(19) United States
(12) Patent Application Publication
(10) Pub. No.: US 2008/0300895 A1
(43) Pub. Date: Dec. 4, 2008

(54) METHOD AND SYSTEM FOR HANDLING RETURNED PAYMENT CARD ACCOUNT STATEMENTS

(76) Inventor: Justin T. Monk, Parker, CO (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 11/757,980

(22) Filed: Jun. 4, 2007

(51) Int. Cl. G06Q 10/00; G06F 17/40

(52) U.S. Cl. 705/1

(57) ABSTRACT

A method and system for handling returned account statements in a payment card system. In one embodiment, upon receipt of a returned account statement corresponding to a consumer's account, an indication is made in the consumer's account that an address of the consumer is invalid; and future mailing of account statements to the address are suppressed. Electronic delivery of the account statement may be activated to an email address of the consumer. In this way, no further account statements are mailed to the invalid address. A customer service representative may be alerted that the address of the consumer is invalid, and upon receiving an updated address from the consumer, and indication can be made in the consumer's account that an address of the consumer is valid, whereupon mailing of future account statements to the updated address can be activated and if desired electronic delivery of the account statement to the email address of the consumer can be terminated.

### FIELD OF THE INVENTION

This invention relates, in general, to payment cards such as but not limited to prepaid credit cards.

### BACKGROUND

Issuers of payment cards, such as banks or other entities that issue payment cards, are required to provide periodic account statements to their customers (e.g., “cardholders”), for instance on a monthly basis. Conventionally, these account statements are mailed to the cardholders via a regular mail, such as through the U.S. Postal Service. However, if the cardholder changes his/her address without notifying the issuer or without notifying the post office of the cardholder's new address, the mailed account statement may not reach the cardholder and instead may be returned by the Postal Service due to the old or invalid address. Returned statements may exist in particular with payment card programs such as payroll programs using reloadable pre-paid payment cards, which are provided to the cardholders by their employers as a means to pay their employees.

As recognized by the present inventor, returned statements are undesirable because they can lead to increased costs for the issuer for statement production, statement mailing, and handling of such returned statements. Moreover, statements sent to an old or invalid address may also increase the risk of identity theft or other fraud on the cardholder's account by an individual (other than the cardholder) that may open and read the account statement.

As recognized by the present inventor, what is needed in one example is a method and system for handling of returned account statements.

It is against this background that the various embodiments of the present invention were developed.

### SUMMARY

According to one broad aspect of one embodiment of the present invention, disclosed herein is a method of handling returned account statements in a payment card system. In one example, the method may include upon receipt of a returned account statement corresponding to a consumer's account (e.g., a cardholder), indicating in the consumer's account that an address of the consumer is invalid; and suppressing mailing of future account statements to the address. The method may also include activating electronic delivery of the account statement to an email address of the consumer. In one embodiment, the account may include a prepaid reloadable payment card. The indicating operation may activate a field in a display indicating that the address of the consumer is invalid.

In another example, the method may include alerting a customer service representative that the address of the consumer is invalid; receiving an updated address from the consumer; and indicating in the consumer's account that an address of the consumer is valid. The method may also include activating mailing of future account statements to the updated address; and suppressing electronic delivery of the account statement to the email address of the consumer.

The features, utilities and advantages of the various embodiments of the invention will be apparent from the following more particular description of embodiments of the invention as illustrated in the accompanying drawings.

### BRIEF DESCRIPTION OF THE DRAWINGS

FIG. 1 illustrates a block diagram of an example of a system for handling returned account statements, in accordance with one embodiment of the present invention.

FIG. 2 illustrates an example of logical operations for handling of returned account statements, in accordance with one embodiment of the present invention.

FIG. 3 illustrates an example of a computer display screen showing an example of a consumer profile with a returned mail field/flag, in accordance with one embodiment of the present invention.

### DETAILED DESCRIPTION

Disclosed herein are various methods, systems and other embodiments that provide for handling of returned account statements in a manner that reduces the transmission/mailing of paper account statements to invalid or old addresses. In one example of the invention, once a returned statement is received by the issuer (other entity that mailed the account statement), a flag is set in a card administration system indicating that the cardholder's address is invalid/bad and future account statements are sent via e-mail or by other electronic means (paper statements are suppressed). When the cardholder calls into customer service, the customer service representative is alerted to the fact that the cardholder's address is invalid and needs updating so that the customer service representative can obtain from the cardholder the cardholder's correct address. Various embodiments of the present invention are disclosed herein.

As used herein, the term “card” or “payment card” includes but is not limited to, for example, credit or debit cards, bank cards, prepaid, preloaded or prefunded cards, such as general purpose reloadable cards, travel cards, payroll cards, teen or student cards, commercial cards, gift cards, or any other type of preloaded, prefunded or prepaid conventional payment card that a customer can use in lieu of a cash payment, and these terms are used interchangeably herein. Such cards are examples of portable consumer devices which may also include phones, key fobs, etc. The term “transaction” includes but is not limited to bill pay, point-of-service purchase, ATM withdrawal, balance inquiry, or any other purchase type activity through prepaid card usage. The term “cardholder” includes but is not limited to, for example, a cardholder of any type of payment card (as that term is used herein), a customer or account holder, and these terms are used interchangeably herein. The term “acquirer” includes but is not limited to the merchant's payment processor, the merchant's bank or financial institution who acquires transactions from merchants and routes messages, authorizations or clearing drafts between merchants and a prepaid card processing network, and these terms are used interchangeably herein. The term “issuer” includes but is not limited to a bank or other financial institution that issues the prepaid cards. The term “processing network” or “network” includes but is not limited to an electronic payment system, or any conventional network or system for authorizing or processing electronic payments.

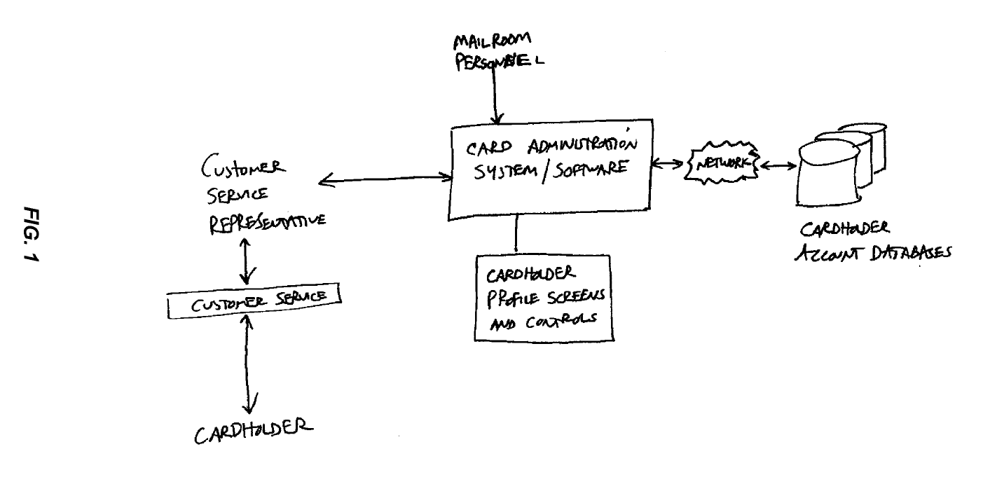

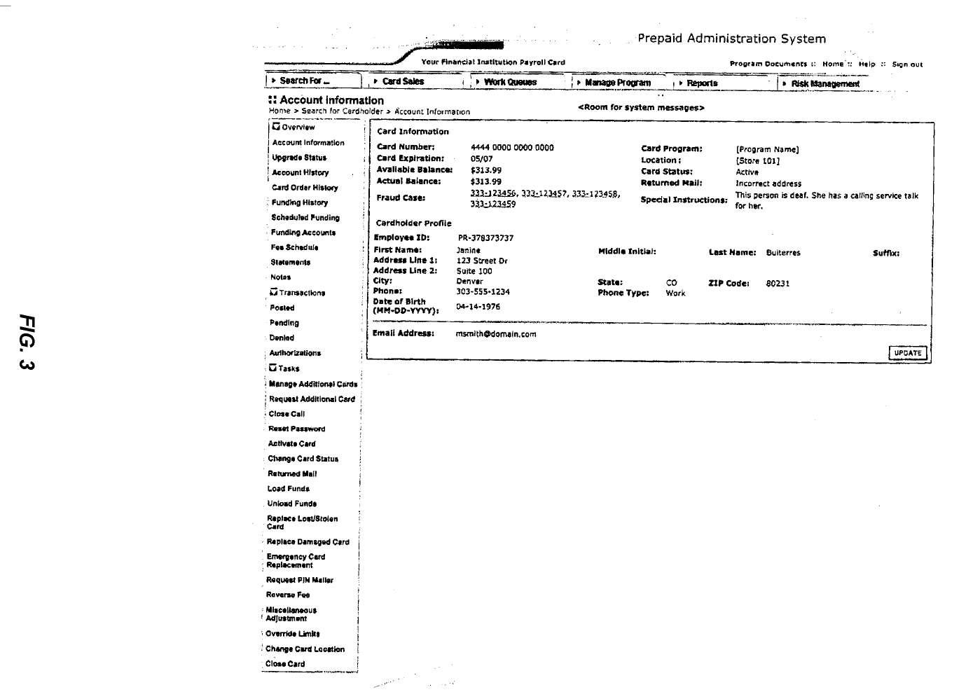

Referring to FIG. 1, a block diagram of a system for handling returned account statements is illustrated, in accordance with one embodiment of the present invention. A card administration system/software component may be provided for use by a customer service representative in viewing information related to a cardholder's account. In one example, the card administration software can be configured to provide various graphical user interfaces, display screens, and controls for a customer service representative to access cardholder account information. The card administration software may be configured to communicate, via a network if desired, with one or more cardholder account databases, which maintain and store account information for a plurality of cardholders. For instance, when a cardholder contacts a customer service representative of the issuer (i.e., via telephone), the customer service representative accesses the cardholder's account information via the card administration software/system and can view one or more cardholder profile screens as desired. One example of a cardholder profile screen is illustrated in FIG. 3, described below.

The card administration software/system may be configured to provide the customer service representative with the ability to input data or associate information with the cardholder's account. The card administration software/system may also include one or more controls, which may be utilized by the customer service representative in order to display profile screens, input data, or perform other functions that may be desired depending upon the particular implementation. In one example, information entered by the customer service representative relating to a cardholder's account is transmitted by the card administration software/system to the account databases, where such information can be stored.

The card administration software/system, in one example, may also be accessible, for example in a limited nature, by individuals such as persons that handle returned account statements received from the postal service, such as mail room personnel of the issuer. In one example, the card administration software can include one or more graphical user interfaces for use by individuals such as mail room personnel, when handling returned account statements. For instance, one or more controls may be provided that permit mail room personnel, upon receipt of an account statement that has been “returned to sender,” to set a flag or indicator associated with a cardholder indicating that an account statement was returned due to an invalid address. The card administration software may be provided with an address entry field for entry of any forwarding address indicated on the returned statement.

While FIG. 1 illustrates an example of a system that may be used for implementing an embodiment of the present invention, it is understood that embodiments of the present invention may be implemented in other systems or environments, depending upon the particular implementation.

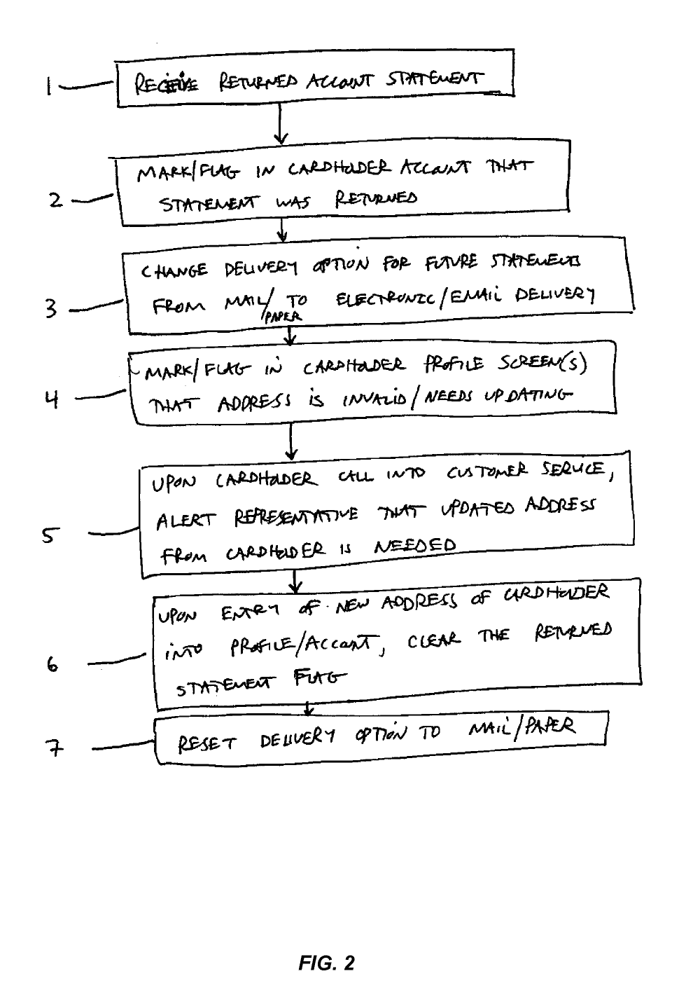

FIG. 2 illustrates an example of logical operations for handling of returned account statements, in accordance with one embodiment of the present invention. At operation one, a returned account statement is received. For example, an account statement that was mailed by the issuer to a cardholder at the last known address of the cardholder may be returned by the Postal Service to the issuer and marked “return to sender.” At operation 2, in response to the receipt of the returned account statement at operation 1, the cardholder account may be marked or flagged to indicate that the last mailed account statement was returned. In one example, operation 2 may be performed by an individual or may be automated through the use of OCR or other automated mail processing technologies. At operation 3, a statement delivery option associated with the cardholder account may be changed from paper/mail to electronic/e-mail delivery, thereby suppressing the mailing of paper statements to the cardholder in the future. In this way, operation 3 prevents future account statements from being mailed through the Postal Service to the invalid/bad address of the account holder. Operation 3 may be an automatic operation that occurs when triggered by operation 2, in one example.

At operation 4, the cardholder's profile (viewable by a customer service representative) is marked or flagged so as to indicate that the cardholder's address of record is invalid and needs updating. At operation 5, upon the cardholder contacting a customer service representative, the customer service representative can be alerted that the cardholder's address is in need of updating. In this way, the customer service representative can then tell the cardholder that a current and valid address for the cardholder is needed. The cardholder can then provide the updated and valid address to the customer service representative, and the customer service representative can enter the updated/valid address into the cardholder profile for association with the cardholder's account.

At operation 6, after the new and valid address of the cardholder has been entered into the cardholder profile and/or account, the returned statement flag of operations 2 and 4 can be cleared, thereby indicating that the current address stored in the cardholder is account database has been updated. At operation 7, the delivery option for transmission of future statements (previously set by operation 3) can be reset to paper/mail so that future account statements are mailed to the cardholder using the updated address provided by the cardholder in operations 5 and/or 6.

Hence, it can be seen that the operations of FIG. 2 prevent the mailing of the future account statements to an old or invalid address after the issuer has received the previous account statement returned to sender by the Postal Service.

FIG. 3 illustrates an example of a computer display screen showing an example of a cardholder profile with a returned mail field/flag, in accordance with one embodiment of the present invention. In this example, the profile may include card information such as the card number, the card expiration date, the available balance, and the profile may include cardholder information such as the cardholder's name, address as stored in the cardholder's accounts, telephone number, and e-mail address. In accordance with an embodiment of the present invention, a field is provided for indicating whether the current address is an incorrect address based on returned mail (i.e., a returned account statement). In the example of FIG. 3, the field is shown as “Returned Mail: Incorrect address” and indicates that the current address in the cardholder's profile is incorrect/bad and resulted in returned mail of a account statement. This field can prompt a customer service representative to ask the cardholder for an updated and valid address. As described above, so long as the “incorrect address” flag/field is active, future account statements are sent electronically to the cardholder to the cardholder's e-mail address and no paper account statements are mailed to the invalid address, according to one embodiment of the present invention.

Embodiments of the invention may be used by payment card companies, issuers such as Banks, processors that handle various aspects of payment card transactions, or other entities. Embodiments of the present invention could be used with any type of payment card, depending on the implementation, including but not limited to credit card, debit cards, prepaid cards, reloadable cards, bank cards, or the like.

Embodiments of the invention can be implemented via appropriate software or computer program code instructions in combination with appropriate instruction execution platforms, processor(s), hardware or the like. These instructions may be in the form of a computer program product that can cause a CPU to control operation of a card administration system according to an embodiment of the invention. The combination of hardware and software to perform the functions described can form the means to carry out the processes and/or subprocesses of embodiments of the invention. In this regard, each block in the flowcharts or block diagrams may represent a module, segment, action, or portion of code, which comprises one or more executable instructions or actions for implementing the specified logical function(s). Furthermore, an embodiment of the invention may take the form of a hardware embodiment, a software embodiment (including firmware, resident software, micro-code, etc.) or an embodiment combining software and hardware aspects.

Any suitable computer usable or computer readable medium may be used, taking into account that computer program code to operate a card administration system according to embodiments of the invention may reside at various places. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device.

In the context of this document, a computer usable or computer readable medium may be any medium that can contain, store, communicate, propagate, or transport the program for use by or in connection with an instruction execution system, platform, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out embodiments of the present invention may be written in an object oriented, scripted or unscripted programming language such as but not limited to Java, Perl, Smalltalk, C++ or the like. However, the computer program code for carrying out embodiments of the present invention may also be written in conventional procedural programming languages, such as the “C” programming language or similar programming languages. It should also be noted that functions and combination of functions described herein can be implemented by special purpose hardware-based systems or operators which perform the specified functions or acts.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operation is not a limitation of the present invention.

It should be appreciated that reference throughout this specification to “one embodiment” or “an embodiment” or “one example” or “an example” means that a particular feature, structure or characteristic described in connection with the embodiment, may be included, if desired, in at least one embodiment of the present invention. Therefore, it should be appreciated that two or more references to “an embodiment” or “one embodiment” or “alternative embodiment” or “one example” or “an example” in various portions of this specification are not necessarily all referring to the same embodiment. Furthermore, the particular features, structures or characteristics may be combined as desired in one or more embodiments of the invention.

What is claimed is:

1. In a payment system, a method of handling returned account statements, comprising:
upon receipt of a returned account statement corresponding to a consumer's account, indicating in the consumer's account that an address of the consumer is invalid; and
suppressing mailing of future account statements to the address.

2. The method of claim 1, further comprising:
activating electronic delivery of the account statement to an email address of the consumer.

3. The method of claim 1, wherein the account include a prepaid reloadable payment card.

4. The method of claim 1, wherein the indicating operation activates a field in a display indicating that the address of the consumer is invalid.

5. The method of claim 1, further comprising:
alerting a customer service representative that the address of the consumer is invalid.

6. The method of claim 1, further comprising:
receiving an updated address from the consumer; and
indicating in the consumer's account that an address of the consumer is valid.

7. The method of claim 6, further comprising:
activating mailing of future account statements to the updated address; and
suppressing electronic delivery of the account statement to the email address of the consumer.

8. The method of claim 1 wherein the consumer is a cardholder and the consumer's account is associated with a payment card.

9. The method of claim 1 wherein the consumer's account is associated with a portable consumer device.

10. A computer readable medium comprising:
code for indicating in the consumer's account that an address of the consumer is invalid upon receipt of a returned account statement corresponding to a consumer's account; and
code for suppressing mailing of future account statements to the address.

11. The computer readable medium of claim 10 further comprising:
code for activating electronic delivery of the account statement to an email address of the consumer.

12. The computer readable medium of claim 10 wherein the account include a prepaid reloadable payment card.

13. The computer readable medium of claim 10 wherein code for indicating comprising code for activating a field in a display indicating that the address of the consumer is invalid.

14. The computer readable medium of claim 10 further comprising:
code for alerting a customer service representative that the address of the consumer is invalid.

15. The computer readable medium of claim 10 further comprising:
code for receiving an updated address from the consumer; and
code for indicating in the consumer's account that an address of the consumer is valid.

16. The computer readable medium of claim 15, further comprising:
code for activating mailing of future account statements to the updated address; and
code for suppressing electronic delivery of the account statement to the email address of the consumer.

17. The computer readable medium of claim 10 wherein the consumer is a cardholder and the consumer's account is associated with a payment card.

18. The computer readable medium of claim 10 wherein the consumer's account is associated with a portable consumer device.

19. A computer comprising a processor, and a computer readable medium according to claim 10, wherein code in the computer readable medium is executable by the processor.
